(19) United States
(12) Patent Application Publication
(10) Pub. No.: US 2011/0220252 A1
(43) Pub. Date: Sep. 15, 2011

(54) DUAL-PHASE STEEL, FLAT PRODUCT MADE OF SUCH A DUAL-PHASE STEEL AND PROCESS FOR THE PRODUCTION OF A FLAT PRODUCT

(75) Inventors: Brigitte Hammer, Voerde (DE); Thomas Heller, Duisburg (DE); Ekaterina Bocharova, Duisburg (DE); Dorothea Mattissen, Mulheim An Der Ruhr (DE); Günter Stich, Bochum (DE); Silke Strauss, Hunxe (DE)

(73) Assignee: TYHSSENKRUPP STEEL EUROPE AG, Duisburg (DE)

(21) Appl. No.: 12/673,279

(22) PCT Filed: Aug. 7, 2008
(86) PCT No.: PCT/EP2008/060382

§ 371 Date: May 5, 2010

(30) Foreign Application Priority Data
Aug. 15, 2007 (EP) 07114399.4

(51) Int. Cl. C21D 8/04; C22C 38/22; B23P 17/00

(52) U.S. Cl. 148/546; 420/104; 29/527.7

(57) ABSTRACT

A dual-phase steel, a flat product and processes for the production thereof. The dual-phase steel having a strength of at least 950 MPa, good deformability, and good surface finish. It is possible, when a simple production process is used, for the flat product produced from this steel to be formed into a complexly formed component, such as part of a car body, either uncoated or provided with an anti-corrosion coating. The steel according to the invention has a structure comprising 20-70% martensite, up to 8% retained austenite and the remainder ferrite and/or bainite and has the following composition (in % by weight): C: 0.050-0.105%, Si: 0.20-0.60%, Mn: 2.10-2.80%, Cr: 0.20-0.80%, Ti: 0.02-0.10%, B: <0.0020%, Mo: <0.25%, Al: <0.10%, Cu: up to 0.20%, Ni: up to 0.10%, Ca: up to 0.005%, P: up to 0.2%, S: up to 0.01%, N: up to 0.012%, remainder iron and unavoidable impurities.

The invention relates to a dual-phase steel, the structure of which substantially consists of martensite and ferrite and respectively bainite, it being possible for portions of retained austenite to be present and the dual-phase steel having a tensile strength of more than 950 MPa. The invention also relates to a flat product produced from a dual-phase steel of this type as well as to a process for the production of a flat product. The generic term “flat product” as used herein typically includes steel strips and sheets of the type according to the invention.

In the field of vehicle body construction, there is a demand for steels which on the one hand have a high strength with a low weight, but on the other hand also have a good deformability. Numerous attempts are known at producing steels which combine these contradictory characteristics.

Thus, for example, EP 1 637 618 A1 discloses a steel which is not only to have an effective deep-drawing property but also a high tensile strength, and a flat product produced therefrom and a process for the production thereof. The known steel contains, in addition to iron and unavoidable impurities (in % by weight) 0.05-0.3% C, up to 1.5% Si, 0.01-3.0% Mn, up to 0.02% P, 0.02% S, up to 0.01% N and 0.01-3.0% Al. The known steel is to have a retained austenite content of at most 7% and should have Mg deposits having a particle diameter of from 0.01 to 5.0 μm with a distribution determined in detail in this document.

The steel composed and obtained in this manner should be particularly effectively deformable and should exhibit a low tendency to fracture formation. Thus, in this prior art, crucial significance is placed on the presence of Mg in the alloy which, according to the description contained in EP 1 637 618 A1, substantially prevents the tendency to fracture formation (“delayed fracture”) which occurs in other known steels of a comparable composition.

To further increase the strength of the steel known from EP 1 637 618 A1, it can optionally also contain, in addition to other selectively added alloying elements, contents of Cr and Mo of in each case 0.005 to 5% by weight as well as from 0.0051 to 2% by weight of Cu, the contents of Cu also being stated as reducing the risk of fracture formation.

A further possibility of producing flat products which consist of relatively high-strength dual-phase steels and which still have good mechanical-technological characteristics even after undergoing an annealing process with the inclusion of an overaging treatment is disclosed in EP 1 200 635 A1. In the process known from this document, a steel strip or sheet is produced which has a predominantly ferritic-martensitic structure in which the martensitic proportion is from 4 to 20%, the steel strip or sheet containing, in addition to Fe and melt-induced impurities, (in % by weight) 0.05-0.2% C, up to 1.0% Si, up to 2.0% Mn, up to 0.1% P, up to 0.015% S, 0.02-0.4% Al, up to 0.005% N, 0.25-1.0% Cr, 0.002-0.01% B. The martensitic proportion of the relevant steel preferably amounts to approximately 5 to 20% of the predominantly martensitic-ferritic structure. A flat product produced in this manner has strengths of at least 500 N/mm² with a simultaneously good forming ability without requiring, for this purpose, particularly high contents of specific alloying elements.

To increase the strength, the transformation-influencing effect of the element boron is drawn on in the case of the steel described in EP 1 200 635 A1. In the known steel, the strength-increasing effect of boron is ensured in that at least one alternative nitride former, preferably Al and additionally Ti is added to the steel material. The effect of adding titanium and aluminium is to bind the nitrogen contained in the steel, such that boron is available to form hardness-increasing carbides. Supported by the necessarily present Cr content, a higher strength level is achieved in this manner compared to comparable steels. However, the maximum strength of the steels stated by way of example in EP 1 200 635 A1 is less than 900 MPa in each case.

Against the background of the prior art described above, the object of the invention was to develop a steel and a flat product produced therefrom which has a strength of at least 950 MPa and a good deformability. Furthermore, the steel should have a surface finish which, when using a simple production process, enables a flat product produced from this steel to be deformed in an uncoated state or in a state provided with an anti-corrosion coating, into a complexly formed component, such as a part of a car bodywork. In addition, a process is also to be provided which makes it easily possible to produce flat products obtained in the manner described above.

With respect to the material, this object is achieved according to the invention by the dual-phase steel stated in claim 1. Advantageous embodiments of this steel are set out in the claims referring to claim 1.

A flat product which achieves the aforementioned object is characterised according to the invention in accordance with claim 21 in that it consists of a steel which is composed and obtained according to the invention.

Finally, with respect to the production process, the aforementioned object is achieved according to the invention by the production methods stated in claims 27 and 28, the process stated in claim 27 relating to the production according to the invention of a hot strip and the procedural method stated in claim 28 relating to the production according to the invention of a cold strip. The claims referring to claims 27 and 28 each contain advantageous variants of the processes according to the invention. In addition, particularly advantageous embodiments are described below for the practical application of the processes according to the invention and of the variants thereof stated in the claims.

A steel according to the invention is characterised by high strengths of at least 950, in particular 980 MPa, and strengths of 1000 MPa and above are routinely achieved. The steel according to the invention simultaneously has a yield strength of at least 580 MPa, in particular at least 600 MPa, and has an elongation A₈₀ of at least 10%.

Due to the combination of high strength and good deformability, the steel according to the invention is particularly suitable for the production of complexly formed components which are heavily stressed in practical use, as required for example in the field of car body construction.

The advantageous combination of characteristics of a steel according to the invention is achieved, inter alia, in that in spite of its high strengths, it has a dual-phase structure. Thus, the alloy of a steel according to the invention is composed such that it has a martensitic proportion of at least 20% up to a maximum of 70%. At the same time, retained austenite proportions of up to 8% can be advantageous, while smaller retained austenite proportions of at most 7% or less are generally preferred. The remainder of the structure of a dual-phase steel according to the invention consists respectively of ferrite and/or bainite (bainitic ferrite+carbides).

The high strengths, good elongation characteristics and optimised surface finish are achieved by the adjustment according to the invention of the dual-phase structure. This is enabled by a narrow choice of the individual contents of the alloying elements which are present in a steel according to the invention in addition to iron and unavoidable impurities.

Thus, the invention provides a C content of from 0.050 to 0.105% by weight. In this respect, the contents of C provided according to the invention have been selected in respect of a best possible weldability of the steel. The advantageous effect of carbon in a steel according to the invention can be used in a particularly reliable manner when the carbon content of a steel according to the invention is from 0.060 to 0.090% by weight, in particular from 0.070 to 0.080% by weight.

Si serves in a steel according to the invention to increase the strength by hardening the ferrite or bainite. In order to be able to use this effect, a minimum Si content of 0.10% by weight is provided, the effect of Si developing in a particularly reliable manner when the Si content of a steel according to the invention is at least 0.2% by weight, in particular at least 0.25% by weight. The risk of grain boundary oxidation is also minimised when this upper limit is observed. In respect of the fact that a flat product produced from a steel according to the invention is to have a surface finish which is optimum for further processing and, if necessary, for applied coatings, the upper limit of the Si content is simultaneously set at 0.6% by weight. An unfavourable influence of Si on the characteristics of the steel according to the invention can be avoided with even greater reliability by restricting the Si content of the steel according to the invention to 0.4% by weight, in particular to 0.35% by weight.

The Mn content of a steel according to the invention is within a range of from 2.10 to 2.80% by weight in order on the one hand to use the strength-increasing effect and on the other to use the positive influence of Mn on the formation of martensite. In the case of the production according to the invention of a cold strip, Mn also has a positive effect in respect of reducing the critical cooling rate after annealing, since it hinders the formation of pearlite. The positive effects of the presence of Mn in a steel according to the invention can then be used in a particularly reliable manner when the Mn content is at least 2.20% by weight, in particular at least 2.45% by weight. Negative influences of Mn on a steel according to the invention, for example a reduction in elongation, impairment to the welding suitability or reduced suitability for hot-dip galvanisation can be ruled out with increased reliability by restricting the Mn content to 2.70% by weight, in particular 2.60% by weight.

Cr also has a strength-increasing effect in a dual-phase steel according to the invention in contents of from 0.2 to 0.8% by weight. The effect of Cr is comparable with the effect of Mn in respect of the critical cooling rate after annealing of a cold strip produced from steel according to the invention. The advantageous effects of Cr are provided in particular when the Cr content is at least 0.3% by weight, in particular at least 0.55% by weight. The Cr content of a steel according to the invention is simultaneously reduced, however, to 0.8% by weight to reduce the risk of the occurrence of grain boundary oxidation and to avoid a negative influence on the extensibility of the steel according to the invention. This is ensured in particular when the upper limit of the chromium content of a steel according to the invention is set at a maximum of 0.7% by weight, in particular at 0.65% by weight.

The presence of titanium in contents of at least 0.02% by weight also contributes to the increase in the strength of a steel according to the invention in that it forms fine deposits of TiC or Ti(C,N) and contributes to the grain refining. A further positive effect of Ti is the binding of nitrogen which may be present, thereby preventing the formation of boron nitrides in the steel according to the invention. These would have a strong negative influence on the elongation characteristics and also on the deformability of a flat product according to the invention. Thus, when boron is added to increase the strength, the presence of Ti also ensures that the boron can fully develop its effect. For this purpose, it can be favourable for Ti to be added in a quantity which is more than 5.1 times the respective N content (i.e. Ti content >1.5 (3.4×N content)). Excessively high Ti contents result, however, in unfavourably high recrystallisation temperatures, which has a particularly negative effect when cold-rolled flat products are produced from steel according to the invention which are annealed in the final processing stage. For this reason, the upper limit of the Ti content is restricted to 0.10% by weight. The positive effect of Ti can be used in a particularly reliable manner on the characteristics of a steel according to the invention when its Ti content is from 0.060 to 0.090% by weight, in particular from 0.070 to 0.085% by weight.

The strength of the steel according to the invention is also increased by the contents of B of up to 0.002% by weight which are optionally provided according to the invention and, as by the respective addition of Mn, Cr and Mo, when cold strip is produced from steel according to the invention, the critical cooling rate is reduced after annealing. For this reason, according to a particularly preferred embodiment of the invention, the B content is at least 0.0005% by weight. However, at the same time excessively high contents of B can reduce the deformability of the steel according to the invention and adversely affect the development of the dual-phase structure which is desired according to the invention. Optimised effects of boron can be used in a steel according to the invention by restricting the boron content to 0.0007-0.0016% by weight, in particular 0.0008-0.0013% by weight.

Like Boron or Cr in the aforementioned content ranges, the contents of molybdenum of at least 0.05% by weight which are optionally present according to the invention also contribute to increasing the strength of a steel according to the invention. In this respect, according to experience, the presence of Mo does not have a negative effect on the coatability of the flat product with a metallic coating or on its extensibility. Practical tests have shown that the positive influences of Mo can be used particularly effectively up to contents of 0.25% by weight, in particular 0.22% by weight, also from a financial point of view. Thus, even contents of 0.05% by weight of Mo have a positive effect on the characteristics of a steel according to the invention. Where there are sufficient quantities of other strength-increasing elements, the desired effect of molybdenum in a steel according to the invention emerges in particular when its Mo content is from 0.065 to 0.18% by weight, in particular from 0.08 to 0.13% by weight. However, particularly if the steel according to the invention contains less than 0.3% by weight of Cr, it is advantageous to add from 0.05 to 0.22% by weight of Mo to ensure the required strength of the steel according to the invention.

When a steel according to the invention is melted, aluminium is used for deoxidisation and for binding nitrogen which may be contained in the steel. For this purpose, Al can be added if necessary in contents of less than <0.1% by weight to the steel according to the invention, the desired effect of Al ensuing in a particularly reliable manner when the contents thereof are within a range of from 0.01 to 0.06% by weight, in particular from 0.020 to 0.050% by weight.

The steel according to the invention can contain up to 0.20% by weight of copper to further increase the strength thereof. A copper content within a range of from 0.08 to 0.12% by weight is particularly advantageous.

Likewise, up to 0.1% by weight of nickel can be added to the steel according to the invention to further improve the hardening ability and accordingly the strength of a steel according to the invention.

Like Al, Ca can be used during the production of the steel for deoxidisation. Furthermore, the presence of Ca in contents of up to 0.005% by weight, in particular from 0.002 to 0.004% by weight can also promote the formation of a fine-grained structure.

Nitrogen is permitted in the steel according to the invention only in contents of up to 0.012% by weight particularly to avoid the formation of boron nitrides when B is simultaneously present. To reliably prevent the respectively present titanium from bonding completely with N and no longer being effective as a micro-alloying element, the N content is preferably restricted to 0.007% by weight.

Low contents of P which are below the upper limit provided according to the invention contribute to the good welding ability of the steel according to the invention. Therefore, according to the invention, the P content is preferably restricted to <0.1% by weight, in particular to <0.02% by weight, particularly good results being obtained with P contents of less than 0.010% by weight.

Where there are contents of sulphur below the upper limit provided according to the invention, the formation of MnS or (Mn,Fe)S is suppressed, thereby ensuring a good extensibility of the steel according to the invention and of the flat products produced therefrom. This is particularly the case when the S content is below 0.003% by weight.

To produce according to the invention a hot strip having a tensile strength of at least 950 MPa and a dual-phase structure consisting from 20 to 70% of martensite, up to 8% of retained austenite and for the remainder of ferrite and/or bainite, a dual-phase steel, composed according to the invention, is firstly melted, the melt is then cast into a pre-product, such as a slab or thin slab, the pre-product is then reheated to or kept at a hot rolling starting temperature of from 1100 to 1300° C., thereupon the pre-product is hot rolled into a hot strip at a hot rolling final temperature of from 800 to 950° C. and finally the hot strip is reeled at a reeling temperature of up to 650° C., in particular 500-650° C.

In a manner according to the invention, flat products consisting of a dual-phase steel according to the invention can be delivered directly, i.e. without a subsequently performed cold rolling process, for further processing as a hot strip obtained after hot rolling. In this respect, it could be demonstrated that hot strip composed according to the invention reacts in an insensitive manner to the change in the reeling temperature and that strengths which are in the region of 1000 MPa and yield strengths of 750 to 890 MPa are constantly attainable.

Similar characteristics are also obtained with hot strips produced from complex-phase steels. However, such steels require a particularly precise adjustment of the reeling temperature. Thus, in practice a maximally admissible deviation from the reeling temperature of only 30° C. applies to hot strips produced from complex-phase steel.

Such high demands imposed on the accuracy of the process management do not exist for hot strips produced according to the invention. Instead, in the production according to the invention of hot strip, the reeling temperature can vary within a wide range in order to purposefully influence the respectively desired characteristics and structural developments. Reeling temperatures particularly suitable for this purpose are within a range of from 500 to 650° C., reeling temperatures of 530 to 580° C. having proved to be particularly advantageous, since with an increased reeling temperature of more than 580° C. the risk of grain boundary oxidation increases and when the reeling temperature is below 500° C., the strength of the hot strip increases to such an extent that a subsequent deformation can be difficult.

It is possible to form highly stressable, complexly designed components, both in an uncoated and coated state, from hot strip obtained according to the invention.

If the hot strip, obtained in the manner according to the invention, is to remain uncoated or is to be electrolytically coated as a hot strip with a metallic coating, the flat product does not have to be annealed. If, on the other hand, the hot strip is to be coated with a metallic coating by hot-dip galvanisation, it is firstly annealed at a maximum annealing temperature of 600° C. and then cooled to the temperature of the coating bath, which can be, for example, a zinc bath. After passing through the zinc bath, the coated hot strip can be cooled to room temperature in a conventional manner.

If flat products of a relatively low thickness are required, then cold strips can also be produced from the composed steel. In a process according to the invention provided for this purpose for the production of a cold strip having a tensile strength of at least 950 MPa and a dual-phase structure which consists to 20-70% of martensite, up to 8% of retained austenite and for the remainder of ferrite and/or bainite, initially a dual-phase steel composed according to the invention is melted, then the melt is cast into a pre-product, such as a slab or thin slab, the pre-product is then reheated to or kept at a hot rolling starting temperature of from 1100 to 1300° C., thereupon the pre-product is hot rolled into a hot strip at a hot rolling final temperature of from 800 to 950° C., the resulting hot strip is reeled at a reeling temperature of up to 650° C., in particular from 500 to 650° C., the hot strip is then cold rolled into a cold strip, thereafter the cold strip is annealed at an annealing temperature of from 700 to 900° C. and finally the cold strip is cooled in a controlled manner.

The cold strip produced thus can also be provided with an anti-corrosion coating.

Reeling temperatures ranging up to 580° C. have proved to be particularly advantageous in connection with the production of a cold strip, because if the reeling temperature of 580° C. is exceeded, the risk of grain boundary oxidation increases. With low reeling temperatures, the strength and yield strength of the hot strip increase such that it becomes increasingly difficult to cold roll the hot strip. Accordingly, the hot strip which is to be cold rolled into a cold strip is preferably reeled at a temperature of at least 500° C., in particular at least 530° C. or at least 550° C.

If the hot strip is cold rolled into a cold strip, it has proved to be favourable to adjust cold rolling degrees of from 40 to 70%, in particular from 50 to 60%. Deformation degrees which are too low are unfavourable in respect of the risk of grain growth during the final annealing step. A cold strip according to the invention which is cold-rolled in this manner typically has thicknesses of from 0.8 to 2.5 mm.

If the flat product according to the invention is provided with a protective metallic coating, this can be performed, for example by hot-dip galvanising, by a galvannealing treatment or by electrolytic coating. If required, a pre-oxidation process can be carried out before coating, in order to ensure a reliable bonding of the metallic coating on the substrate to be respectively coated.

If the cold strip produced according to the invention is to remain uncoated or is to be coated electrolytically, an annealing treatment is carried out in a continuous annealing furnace as a separate working step. The maximum annealing temperatures which are achieved in so doing are within a range of from 700 to 900° C. at heating rates of from 1 to 50 K/s. Subsequently, for the intentional adjustment of the combination of characteristics desired according to the invention, the annealed cold strip is preferably cooled such that cooling rates of at least 10 K/s are achieved within a temperature range of from 550 to 650° C. in order to suppress the formation of pearlite. After reaching the temperature in this critical range, the strip can be kept for a period of 10 to 100 s or can be cooled directly to room temperature at a cooling rate of from 0.5 to 30 K/s.

However, if the cold strip is to be coated by hot dip galvanisation, the annealing and coating steps can be combined. In this case, the cold strip passes in a continuous sequence through various furnace sections of a hot dip coating line, different temperatures prevailing in the individual furnace sections and reaching a maximum of from 700 to 900° C., in which case heating rates ranging from 2 to 100 K/s should be selected. After the respective annealing temperature has been attained, the strip is then kept at this temperature for 10 to 200 s. The strip is then cooled to the temperature, usually below 500° C., of the respective coating bath which is typically a zinc bath, and in this case as well the cooling rate should be more than 10 K/s within a temperature range of from 550 to 650° C. After reaching this temperature stage, the cold strip can optionally be kept at the respective temperature for 10 to 100 s. The annealed cold strip then passes through the respective coating bath which is preferably a zinc bath. Subsequently, the cold strip is either cooled to room temperature in order to obtain a conventionally hot-dip galvanised cold strip, or is rapidly heated, then cooled to room temperature to produce a galvannealed cold strip.

If necessary after the annealing treatment, the cold strip can undergo a skin pass rolling in a coated or uncoated state, with the adjustment of skin pass rolling degrees ranging up to 2%.

The invention will be described in detail in the following with reference to practical examples.

Sixteen steel melts 1-16, the compositions of which are stated in Table 1 were melted in conventional manner and cast into slabs. The slabs were then reheated in a furnace to 1200° C. and hot rolled in conventional manner starting from this temperature. The final rolling temperature was 900° C.

For a first series of tests, the hot strips obtained thus were reeled at a reeling temperature of 550° C. which was adjusted with an accuracy of +/−30° C., before they were cold rolled with a cold rolling degree of 50%, 65% and 70% into a cold strip having a thickness of from 0.8 mm to 2 mm.

Table 2 states the structural state, the mechanical characteristics and the respectively adjusted degrees of cold rolling and the strip thicknesses for the cold strips produced in the first series of test from melts 1 to 16.

In four further series of tests, the hot strips produced from melts 1 to 16 in the manner described above were reeled at a reeling temperature below 100° C., at a temperature of 500° C., at a temperature of 600° C. and at a temperature of 650° C. The characteristics determined for these hot strips are stated in Table 3 (reeling temperature 20° C.), Table 4 (reeling temperature=500° C.), Table 5 (reeling temperature=580° C.) and Table 6 (reeling temperature=650° C.). The hot strips obtained thus were not intended for cold rolling, but were forwarded for further processing into components, optionally after being provided with a protective metallic coating.

TABLE 1

| Melt | C | Si | Mn | Al | Mo | Ti | Cr | B | P | S | N |
|---|---|---|---|---|---|---|---|---|---|---|---|
| 1 | 0.087 | 0.18 | 2.22 | 0.007 | 0.100 | 0.050 | 0.60 | 0.001 | 0.007 | 0.004 | 0.0045 |
| 2 | 0.069 | 0.28 | 2.62 | 0.04 | 0.092 | 0.080 | 0.58 | 0.0015 | 0.008 | 0.0015 | 0.0031 |
| 3 | 0.095 | 0.23 | 2.27 | 0.031 | 0.10 | 0.075 | 0.62 | 0.0012 | 0.013 | 0.002 | 0.0051 |
| 4 | 0.089 | 0.22 | 2.31 | 0.034 | 0.050 | 0.081 | 0.64 | 0.0017 | 0.012 | 0.0021 | 0.0036 |
| 5 | 0.091 | 0.31 | 2.52 | 0.034 | 0.150 | 0.052 | 0.42 | 0.0011 | 0.009 | 0.003 | 0.0046 |
| 6 | 0.060 | 0.26 | 2.15 | 0.041 | 0.250 | 0.051 | 0.25 | 0.001 | 0.012 | 0.0019 | 0.0052 |
| 7 | 0.102 | 0.15 | 2.26 | 0.038 | 0.050 | 0.090 | 0.80 | 0.0018 | 0.009 | 0.0021 | 0.0049 |
| 8 | 0.065 | 0.60 | 2.64 | 0.032 | 0.095 | 0.025 | 0.45 | 0.0012 | 0.014 | 0.0017 | 0.0039 |
| 9 | 0.063 | 0.16 | 2.10 | 0.035 | 0.240 | 0.063 | 0.71 | 0.0011 | 0.008 | 0.0021 | 0.0046 |
| 10 | 0.092 | 0.35 | 2.12 | 0.032 | 0.098 | 0.077 | 0.46 | 0.0017 | 0.013 | 0.003 | 0.0033 |
| 11 | 0.100 | 0.21 | 2.34 | 0.042 | 0.130 | 0.065 | 0.47 | 0.0018 | 0.014 | 0.0017 | 0.0032 |
| 12 | 0.072 | 0.50 | 2.65 | 0.031 | 0.160 | 0.089 | 0.32 | 0.0014 | 0.009 | 0.0021 | 0.005 |
| 13 | 0.076 | 0.34 | 2.39 | 0.037 | 0.200 | 0.057 | 0.54 | 0.0015 | 0.012 | 0.0015 | 0.0047 |
| 14 | 0.084 | 0.23 | 2.52 | 0.037 | 0.060 | 0.031 | 0.63 | 0.001 | 0.008 | 0.0033 | 0.0032 |
| 15 | 0.092 | 0.15 | 2.27 | 0.033 | 0.210 | 0.035 | 0.75 | 0.0013 | 0.014 | 0.0018 | 0.0041 |
| 16 | 0.083 | 0.05 | 2.20 | 0.032 | 0.170 | 0.070 | 0.80 | 0.0016 | 0.013 | 0.0018 | 0.0032 |

Amounts in % by weight, remainder iron and unavoidable impurities

TABLE 2

| | | | | Structure | | | | |
|---|---|---|---|---|---|---|---|---|
| | | | | | | Retained | Degree of | |
| | R_{p0.2} | Rₘ | A₈₀ | | | austenite | cold-rolling | Thickness |
| Melt | [MPa] | | [%] | Matrix | Martensite [%] | [%] | [%] | [mm] |
| 1 | 601 | 980 | 14.8 | Ferrite/bainite | 35-40 | 3 | 50 | 2 |
| 2 | 659 | 1038 | 15.9 | Bainite/ferrite | 40-50 | 2 | 50 | 2 |
| 3 | 621 | 1012 | 14.6 | Bainite/ferrite | 35-45 | 1 | 65 | 1.2 |
| 4 | 596 | 996 | 15.1 | Ferrite/bainite | 30-40 | 7 | 50 | 2 |
| 5 | 612 | 1021 | 13.8 | Ferrite/bainite | 45-55 | 2 | 70 | 0.8 |
| 6 | 635 | 1036 | 16.8 | Bainite/ferrite | 55-65 | 1.5 | 70 | 0.8 |
| 7 | 675 | 1079 | 13.7 | Bainite | 60-70 | 1 | 50 | 2 |
| 8 | 580 | 964 | 15.2 | Ferrite/bainite | 20-30 | 2 | 65 | 1.2 |
| 9 | 613 | 1030 | 15.6 | Bainite/ferrite | 45-55 | 3 | 70 | 0.8 |
| 10 | 665 | 1042 | 14.5 | Bainite/ferrite | 60-70 | 1 | 70 | 0.8 |
| 11 | 597 | 977 | 16.7 | Ferrite/bainite | 25-35 | 3 | 50 | 2 |
| 12 | 645 | 1063 | 14.7 | Bainite | 55-65 | 1 | 50 | 2 |
| 13 | 624 | 1003 | 16.3 | Ferrite/bainite | 30-40 | 5 | 65 | 1.2 |
| 14 | 627 | 998 | 14.2 | Ferrite/bainite | 30-40 | 2 | 65 | 1.2 |
| 15 | 589 | 985 | 15 | Ferrite/bainite | 30-40 | 3 | 50 | 2 |
| 16 | 616 | 1026 | 14.5 | Bainite/ferrite | 45-55 | 1 | 70 | 0.8 |

TABLE 3

| | R_{p0.2} | Rₘ | A₈₀ | Structure | |
|---|---|---|---|---|---|
| Melt | [MPa] | [MPa] | [%] | Matrix | Martensite [%] |
| 1 | 936 | 1013 | 9.3 | Bainite | 30-35 |
| 2 | 810 | 1011 | 10.1 | Bainite | 30 |
| 3 | 860 | 995 | 11.2 | Bainite | 25-30 |
| 4 | 796 | 1037 | 10.9 | Bainite | 45 |
| 5 | 818 | 999 | 9.8 | Bainite | 30 |
| 6 | 838 | 996 | 10.2 | Bainite | 30 |
| 7 | 803 | 992 | 9.8 | Bainite | 25-30 |
| 8 | 846 | 1013 | 10.9 | Bainite | 30-40 |
| 9 | 923 | 1050 | 10.3 | Bainite | 35-40 |
| 10 | 890 | 1034 | 10.1 | Bainite | 35-40 |
| 11 | 820 | 1011 | 10.4 | Bainite/bainitic | 30 |
| | | | | ferrite | |
| 12 | 910 | 1025 | 9.8 | Bainite/bainitic | 30-35 |
| | | | | ferrite | |
| 13 | 879 | 1015 | 11.1 | Bainite/bainitic | 25-30 |
| | | | | ferrite | |
| 14 | 865 | 1026 | 9.7 | Bainite | 35 |
| 15 | 804 | 997 | 10.8 | Bainite | 20 |
| 16 | 906 | 1042 | 10.1 | Bainite | 40-45 |

TABLE 4

| | | | | Structure | |
|---|---|---|---|---|---|
| | R_{p0.2} | Rₘ | A₈₀ | | Martensite |
| Melt | [MPa] | [MPa] | [%] | Matrix | [%] |
| 1 | 802 | 984 | 9.5 | Bainite/portions of | 20 |
| | | | | globular ferrite | |
| 2 | 810 | 1011 | 10.1 | Bainite/bainitic | 25-30 |
| | | | | ferrite, portions of | |
| | | | | globular ferrite | |
| 3 | 752 | 988 | 11.2 | Bainite/bainitic | 20-25 |
| | | | | ferrite, portions of | |
| | | | | globular ferrite | |
| 4 | 838 | 978 | 11.3 | Bainite/portions of | 20 |
| | | | | globular ferrite | |
| 5 | 810 | 1009 | 11.2 | Bainite/portions of | 20-25 |
| | | | | globular ferrite | |
| 6 | 760 | 967 | 11.6 | Bainite/portions of | 20 |
| | | | | globular ferrite | |
| 7 | 807 | 1007 | 10.1 | Bainite/bainitic | 20 |
| | | | | ferrite, portions of | |
| | | | | globular ferrite | |
| 8 | 814 | 983 | 9.1 | Bainite/portions of | 20-25 |
| | | | | globular ferrite | |
| 9 | 876 | 1037 | 11 | Bainite/portions of | 30 |
| | | | | globular ferrite | |
| 10 | 864 | 1023 | 9.8 | Bainite/bainitic | 30-35 |
| | | | | ferrite, portions of | |
| | | | | globular ferrite | |
| 11 | 789 | 998 | 10.6 | Bainite/bainitic | 20 |
| | | | | ferrite, portions of | |
| | | | | globular ferrite | |
| 12 | 832 | 1003 | 10.5 | Bainite/bainitic | 20-25 |
| | | | | ferrite, portions of | |
| | | | | globular ferrite | |
| 13 | 851 | 1006 | 11.9 | Bainite/portions of | 20-25 |
| | | | | globular ferrite | |
| 14 | 824 | 997 | 9.8 | Bainite/bainitic | 20 |
| | | | | ferrite, portions of | |
| | | | | globular ferrite | |
| 15 | 798 | 986 | 11 | Bainite/bainitic | 20-25 |
| | | | | ferrite, portions of | |
| | | | | globular ferrite | |
| 16 | 854 | 1011 | 10.2 | Bainite/bainitic | 25-30 |
| | | | | ferrite, portions of | |
| | | | | globular ferrite | |

TABLE 5

| | | | | Structure | |
|---|---|---|---|---|---|
| | R_{p0.2} | Rₘ | A₈₀ | | Martensite |
| Melt | [MPa] | [MPa] | [%] | Matrix | [%] |
| 1 | 787 | 1000 | 11.1 | Bainite/bainitic | 25 |
| | | | | ferrite, portions of | |
| | | | | globular ferrite | |
| 2 | 821 | 1012 | 12.2 | Bainite/portions of | 30 |
| | | | | globular ferrite | |
| 3 | 795 | 998 | 9.3 | Bainite/bainitic | 20-25 |
| | | | | ferrite, portions of | |
| | | | | globular ferrite | |
| 4 | 787 | 1001 | 10.7 | Bainite/portions of | 25 |
| | | | | globular ferrite | |
| 5 | 822 | 1013 | 11.2 | Bainite/bainitic | 30 |
| | | | | ferrite, portions of | |
| | | | | globular ferrite | |
| 6 | 792 | 998 | 9.6 | Bainite/portions of | 20-25 |
| | | | | globular ferrite | |
| 7 | 862 | 1003 | 10.9 | Bainite/portions of | 20-25 |
| | | | | globular ferrite | |
| 8 | 826 | 991 | 10.2 | Bainite/portions of | 20-25 |
| | | | | globular ferrite | |
| 9 | 812 | 1003 | 12.4 | Bainite/bainitic | 30 |
| | | | | ferrite, portions of | |
| | | | | globular ferrite | |
| 10 | 898 | 1065 | 11 | Bainite/bainitic | 30-35 |
| | | | | ferrite, portions of | |
| | | | | globular ferrite | |
| 11 | 780 | 994 | 10.6 | Bainite/portions of | 20-25 |
| | | | | globular ferrite | |
| 12 | 866 | 987 | 10.4 | Bainite/portions of | 20-25 |
| | | | | globular ferrite | |
| 13 | 784 | 998 | 11.1 | Bainite/bainitic | 20 |
| | | | | ferrite, portions of | |
| | | | | globular ferrite | |
| 14 | 802 | 1002 | 11 | Bainite/bainitic | 20-25 |
| | | | | ferrite, portions of | |
| | | | | globular ferrite | |
| 15 | 826 | 991 | 10.2 | Bainite/portions of | 20-25 |
| | | | | globular ferrite | |
| 16 | 833 | 1008 | 11.4 | Bainite/portions of | 20-25 |
| | | | | globular ferrite | |

TABLE 6

| | | | | Structure | |
|---|---|---|---|---|---|
| | R_{p0.2} | Rₘ | A₈₀ | | Martensite |
| Melt | [MPa] | [MPa] | [%] | Matrix | [%] |
| 1 | 833 | 1034 | 14.6 | Bainite (bainitic | 25 |
| | | | | ferrite, 4% retained | |
| | | | | austenite, carbide | |
| | | | | deposits), portions of | |
| | | | | globular ferrite | |
| 2 | 760 | 1004 | 17.3 | Bainite (bainitic | 20 |
| | | | | ferrite, 4% retained | |
| | | | | austenite, carbide | |
| | | | | deposits) | |
| 3 | 821 | 1014 | 10.7 | Bainite (bainitic | 25 |
| | | | | ferrite, 2% retained | |
| | | | | austenite, carbide | |
| | | | | deposits), portions of | |
| | | | | globular ferrite | |
| 4 | 862 | 1016 | 10.4 | Bainite (bainitic | 20-25 |
| | | | | ferrite, <1% | |
| | | | | retained austenite, | |
| | | | | carbide deposits), | |
| | | | | portions of globular | |
| | | | | ferrite | |
| 5 | 829 | 996 | 16.7 | Bainite (bainitic | 20 |
| | | | | ferrite, 3% retained | |
| | | | | austenite, carbide | |
| | | | | deposits), portions of | |
| | | | | globular ferrite | |
| 6 | 807 | 1014 | 15.9 | Bainite (bainitic | 20 |
| | | | | ferrite, 4.5% retained | |
| | | | | austenite, carbide | |
| | | | | deposits), portions of | |
| | | | | globular ferrite | |
| 7 | 742 | 990 | 18.2 | Bainite (bainitic | 20 |
| | | | | ferrite, 2% retained | |
| | | | | austenite, carbide | |
| | | | | deposits), portions of | |
| | | | | globular ferrite | |
| 8 | 867 | 1046 | 10.8 | Bainite (bainitic | 20-25 |
| | | | | ferrite, 1% retained | |
| | | | | austenite, carbide | |
| | | | | deposits) | |
| 9 | 780 | 1003 | 16.3 | Bainite (bainitic | 20 |
| | | | | ferrite, 3.5% retained | |
| | | | | austenite, carbide | |
| | | | | deposits) | |
| 10 | 887 | 1007 | 9.5 | Bainite (bainitic | 20 |
| | | | | ferrite, <1% retained | |
| | | | | austenite, carbide | |
| | | | | deposits) | |
| 11 | 787 | 1024 | 15.8 | Bainite (bainitic | 20 |
| | | | | ferrite, 4% retained | |
| | | | | austenite, carbide | |
| | | | | deposits) | |
| 12 | 822 | 985 | 16.3 | Bainite (bainitic | 20 |
| | | | | ferrite, 2% retained | |
| | | | | austenite, carbide | |
| | | | | deposits), portions of | |
| | | | | globular ferrite | |
| 13 | 782 | 1001 | 10 | Bainite (bainitic | 25 |
| | | | | ferrite, <1% retained | |
| | | | | austenite, carbide | |
| | | | | deposits), portions of | |
| | | | | globular ferrite | |
| 14 | 824 | 1029 | 13.9 | Bainite (bainitic | 20 |
| | | | | ferrite, 3.5% retained | |
| | | | | austenite, carbide | |
| | | | | deposits) | |
| 15 | 848 | 1027 | 11.7 | Bainite (bainitic | 20 |
| | | | | ferrite, 2% retained | |
| | | | | austenite, carbide | |
| | | | | deposits), portions of | |
| | | | | globular ferrite | |
| 16 | 779 | 1004 | 15.3 | Bainite (bainitic | 20 |
| | | | | ferrite, 4% retained | |
| | | | | austenite, carbide | |
| | | | | deposits), portions of | |
| | | | | globular ferrite | |

1-31. (canceled)

32. A dual-phase steel, having a structure comprising 20-70% martensite, up to 8% retained austenite and the remainder ferrite and/or bainite and a tensile strength of at least 950 MPa, comprising (in % by weight):

| | | | |
|---|---|---|---|
| C: | 0.050 | — | 0.105%, |
| Si: | 0.20 | — | 0.60%, |
| Mn: | 2.10 | — | 2.80%, |
| Cr: | 0.20 | — | 0.80%, |
| Ti: | 0.02 | — | 0.10%, |
| B: | | < | 0.0020%, |
| Mo: | | < | 0.25%, |
| Al: | | < | 0.10%, |
| Cu: | | up to | 0.20%, |
| Ni: | | up to | 0.10%, |
| Ca: | | up to | 0.005%, |
| P: | | up to | 0.2%, |
| S: | | up to | 0.01%, |
| N: | | up to | 0.012% |

the remainder being iron and unavoidable impurities.

33. The dual-phase steel according to claim 32, wherein the yield strength thereof is at least 580 MPa.

34. The dual-phase steel according to claim 32, wherein the elongation A₈₀ thereof is at least 10%.

35. The dual-phase steel according to claim 32, wherein the P content thereof is <0.1% by weight.

36. The dual-phase steel according to claim 32, wherein the C content thereof is from 0.06 to 0.09% by weight.

37. The dual-phase steel according to claim 32, wherein the Si content thereof is from 0.20 to 0.40% by weight.

38. The dual-phase steel according to claim 32, wherein the Mn content thereof is from 2.20 to 2.70% by weight.

39. The dual-phase steel according to claim 32, wherein the Cr content thereof is from 0.40 to 0.70° A) by weight.

40. The dual-phase steel according to claim 32, wherein the Ti content thereof is from 0.060 to 0.090% by weight.

41. The dual-phase steel according to claim 32, wherein in the presence of N, the Ti content of said dual-phase steel is more than 5.1 times the respective N content.

42. The dual-phase steel according to claim 32, wherein the B content thereof is from 0.0005 to 0.002% by weight.

43. The dual-phase steel according to claim 42, wherein the B content thereof is from 0.0007 to 0.0015% by weight.

44. The dual-phase steel according to claim 32, wherein the Mo content thereof is from 0.05 to 0.20% by weight.

45. The dual-phase steel according to claim 44, wherein the Cr content thereof is 0.2-0.3% by weight.

46. The dual-phase steel according to claim 44, wherein the Mo content thereof is from 0.065 to 0.150% by weight.

47. The dual-phase steel according to claim 32, wherein the Al content thereof is from 0.01 to 0.06% by weight.

48. The dual-phase steel according to claim 32, wherein the Cu content thereof is from 0.07 to 0.13% by weight.

49. The dual-phase steel according to claim 32, wherein the S content thereof is <0.003% by weight.

50. The dual-phase steel according to claim 32, wherein the N content thereof is <0.007% by weight.

51. The dual-phase steel according to claim 32, wherein the retained austenite content thereof is less than 7%.

52. A flat product comprising a dual-phase steel obtained according to claim 32.

53. The flat product according to claim 52, wherein it is a hot strip which has only been hot-rolled.

54. The flat product according to claim 52, wherein it is a cold strip obtained by cold rolling.

55. The flat product according to claim 52, further comprising a protective metallic coating.

56. The flat product according to claim 55, wherein the protective metallic coating is produced by hot-dip galvanisation.

57. The flat product according to claim 55, wherein the protective metallic coating is produced by galvannealing.

58. A process for the production of a hot strip having a tensile strength of at least 950 MPa and a dual-phase structure comprising 20-70% martensite, up to 8% retained austenite and the remainder ferrite and/or bainite, comprising the following steps:
melting a dual-phase steel composed according to claim 32,
casting the melt into a pre-product, such as slab or thin slab,
reheating to or keeping the pre-product at a starting hot rolling temperature of 1100-1300° C.
hot rolling the pre-product at a final hot rolling temperature of 800-950° C. into a hot strip, and
reeling the hot strip at a reeling temperature of up to 650° C.

59. A process for the production of a cold strip having a tensile strength of at least 950 MPa and a dual-phase structure comprising 20-70% martensite, up to 8% retained austenite and the remainder of ferrite and/or bainite, comprising the following steps:
melting a dual-phase steel composed according to claim 32,
casting the melt into a pre-product, such as slab or thin slab,
reheating to or keeping the pre-product at a starting hot rolling temperature of 1100-1300° C.,
hot rolling the pre-product at a final hot rolling temperature of 800-950° C. into a hot strip,
reeling the hot strip at a reeling temperature of up to 650° C.,
cold-rolling the hot strip into a cold strip,
annealing the cold strip at an annealing temperature of 700-900° C., and
cooling the annealed cold strip in a controlled manner.

60. The process according to claim 58, wherein the reeling temperature is higher than 500° C. up to 580° C.

61. The process according to claim 59, wherein the hot strip is cold-rolled into a cold strip with a degree of cold-rolling of from 40 to 70%.

62. The process according to claim 59, wherein the controlled cooling is carried out within a temperature range of from 550 to 650° C. at a cooling rate of at least 10 K/s.
